(19) United States
(12) Patent Application Publication
(10) Pub. No.: US 2022/0015309 A1
(43) Pub. Date: Jan. 20, 2022

(54) Substrate for Producing Consumer-Ready Vegetables, Mushrooms or Herbs in a Closed Container

(71) Applicant: Rijk Zwaan Zaadteelt en Zaadhandel B.V., De Lier (NL)

(72) Inventors: Kalin Kong, De Lier (NL); Jeanette Diana Van Der Laken, De Lier (NL)

(21) Appl. No.: 17/294,840

(22) PCT Filed: Dec. 19, 2019
(86) PCT No.: PCT/EP2019/086371

§ 371 Date: May 18, 2021

(30) Foreign Application Priority Data
Dec. 21, 2018 (NL) 2022282

(51) Int. Cl. A01G 24/30; C08L 67/02; A01G 22/00; A01G 18/20; A01G 24/44

(52) U.S. Cl. CPC A01G 24/30; C08L 67/02; A01G 24/44; A01G 18/20; A01G 22/00

(57) ABSTRACT

Disclosed are a substrate a container and a method for producing consumer-ready vegetables, mushrooms or herbs, a method of producing the substrate, and use of the substrate for producing consumer-ready vegetables, mushrooms or herbs. The substrate comprises a polymer fiber based body having a porous structure, wherein the polymer fiber based body comprises a sowing material receiving surface for receiving sowing material of the vegetables, mushrooms or herbs, wherein the polymer fiber based body comprises polyethylene terephthalate, PET, fiber material.

The present patent disclosure relates to a substrate, a container and a method for producing consumer-ready vegetables, mushrooms or herbs, a method of producing the substrate, and use of the substrate for producing consumer-ready vegetables, mushrooms or herbs. The present patent disclosure relates in particular to a substrate on which vegetables, mushrooms or herbs and the sowing and planting material thereof are able to grow in a closed container.

Vegetables, mushrooms and herbs are traditionally produced by specialized growers in greenhouses or on fields. After harvest, the produce is transported to e.g. a distributor or retail outlet. Due to transportation time, the harvest loses its freshness and may start to deteriorate in quality, requiring specialized transport and storage facilities.

Patent document WO 2014/056869 A1 describes a new way of producing vegetables, herbs and mushrooms, wherein plants are grown in a closed container provided with growth medium. Sowing material is placed on a substrate, which is placed in the container. Growth medium is added to the container. The container is thereafter closed with a semi permeable membrane that allows the exchange of growth-related substances such as oxygen and carbon dioxide, but blocks unwanted substances such as pathogens.

The substrate is often not sufficiently permeable to oxygen. Also, the substrate does not always sufficiently allow roots to grow through. Furthermore, the substrates may not provide sufficiently fast transport of the growth medium lying in the bottom of the container towards the top of the substrate such that the growing vegetables, herbs and mushrooms are provided with insufficient growth medium.

Patent document WO 2004/098270 A1 describes hydroponic plant growth using a growth medium containing a fibrous pad of biodegradable cellulose fibers, bicomponent binder fibers and optionally, a binder. The growth medium can contain a bonded fibrous pad of matrix fibers, either synthetic or cellulose or both, and bicomponent binder fibers having affinity for the respective matrix fibers, and optionally a second type of binder. Fiberized fluff cellulose fibers used in the composite structure are selected from wood cellulose, cotton linter pulp, chemically modified cellulose or highly purified cellulose fibers. The fluff fibers may be blended with synthetic fibers such as polyester, PET, nylon, polyethylene or polypropylene. The use of biological material such as wood fibers or cellulose material in the growth medium is unsuitable for producing consumer-ready vegetables, mushrooms or herbs in a closed containers, e.g. due to microorganism growth. Furthermore, it is found that it is difficult to sterilize substrates comprising or consisting of cellulose which have a thickness that is required for their application in closed containers.

It is an object among objects of the present patent disclosure to provide an improved substrate.

According to a first aspect, there is provided a substrate for producing consumer-ready vegetables, mushrooms or herbs in a closed container, comprising: a polymer fiber based body having a porous structure, wherein the polymer fiber based body comprises a sowing material receiving surface for receiving sowing material of the vegetables, mushrooms or herbs, wherein the polymer fiber based body is made of only, or consists of, polyethylene terephthalate, PET, fiber material.

It is found that the substrate, having the PET fiber material, is sufficiently porous to allow roots and the like to grow through, to sufficiently allow for growth medium transport from a lower side of the substrate to the growth material receiving surface and is permeable to oxygen. The polymer fiber based body consists of PET fiber material. In other words, the polymer fiber based body is made of only PET fiber material. Advantageously, this simplifies the production process of the substrate. In addition, it is found that use of PET fiber material alone is beneficial for obtaining, and retaining, a relatively high sterility of the substrate. This is highly advantageous especially when used in closed containers for producing consumer-ready vegetables, mushrooms or herbs.

Preferably, the polymer fiber based body is substantially sterile, e.g. when sterilized by a sterilization process. Substantially sterile here indicates that a substrate is obtained in which during the growth time (e.g. two to four weeks) in the container, the crop grows without pathogens and contaminants harming the growth. The polymer fiber based body being substantially sterile is especially advantageous, since in practice there is a high risk of contamination of the growth medium by pathogens in the related art containers, especially when the growth medium comprises nutrients which promote bacterial growth. Although PET fiber material is used in other far away fields like sound proofing and insulation, surprisingly it is found that the substrate according to the first aspect is readily sterilized and remains substantially sterile when used in the closed container. Advantageously, the PET fiber material substrate may be recycled, thus providing a sustainable substrate.

Furthermore, the PET fiber material substrate does not react with the growth medium, which generally comprises water and also PET is safe to use in food products. The substrate according to the present application beneficially stays together, thus keeping the grown product substantially clean of inedible substances.

The substrate in an embodiment comprises a plurality of substrates. Each substrate can be different depending on the crop to be grown thereon, and the respective growth time of that crop. The container is optionally compartmentalized, each compartment having a base to receive a respective one of the plurality of substrates.

The growth medium may comprise water and at least one of the ingredients from the group consisting of minerals (major salts as well as minor salts), sugars, trace elements, vitamins and amino acids.

In an embodiment, the substrate further comprises the sowing material of the vegetables, mushrooms or herbs. Preferably, the sowing material comprises at least one of seeds, seedlings, shredded and singulated plant material, plant somatic embryos, adventive or axillary shoots or parts thereof, spores and mycelium. Most preferably, the sowing material is a plurality of seeds of vegetables or herbs.

Examples of consumer-ready vegetables are leafy vegetables, in particular, lettuce, endive, rucola, lamb lettuce, corn salad, chard, leaf beet, spinach or radish. The vegetables can also be sprout vegetables, such as cress, beet sprouts, alfalfa, broccoli sprouts, bean sprouts, fennel sprouts, cabbage sprouts, garlic sprouts, leek sprouts, pea sprouts, chickpea sprouts, radish sprouts. Examples of mushrooms are Agaricus bisporus, Pleurotus ostreatus, Volvariella volvacea, Lentinus edodes and Cantharellus cibarius. Examples of herbs are chives, parsley, basil, dill, coriander, cilantro, mint, oregano, rosemary, thyme, marjoram, lemon balm, tarragon, sage.

In an embodiment, the substrate further comprises a biocompatible adhesive layer provided on at least a part of the surface of the substrate. It is preferred that at least a part of the sowing material is at least partially fixed to the sowing material receiving surface of the substrate using the biocompatible adhesive.

Preferably, the substrate further comprises a seed mat, wherein the sowing material is enclosed by, or at least partially fixed to, the seed mat. Optionally, the seed mat is fixed to the sowing material receiving surface using the biocompatible adhesive. In this way, the at least one of the plurality of seeds are at least partially fixed to the seed receiving surface of the substrate. Especially when attempting to grow crops with smaller seeds, such as rucola, without a seed mat the seeds can fall into pores of the PET fiber material, such that the use of a seed mat is especially beneficial in combination with the substrate according to the present disclosure.

In an embodiment, the PET fiber material has a density of 5 to 40 kg/m³. In this range, as compared to outside this range, the PET fiber material is dense enough such that the liquid growth medium can be transported from a part or surface of the substrate opposite the sowing material receiving surface to the sowing material receiving surface, and not too dense, such that roots of germinating seeds can readily grow through the PET fiber material. Preferably, the PET fiber material density is 10 to 20 kg/m³. Most preferably the density of the PET fiber material is 14 to 19 kg/m³. Examples are 16.7 kg/m³ and 17.5 kg/m³. The latter range provides a PET fiber material that is sufficiently strong and light, while its thickness can be chosen such that at most 30% of the height of the container is used by the substrate.

The more dense the fiber material, the smaller its pore size and the higher the liquid level will be due to e.g. capillary action, such that a thicker fiber material is required in order to have a suitable moisture level at the height of the sowing material. Also, higher density fiber material may absorb more of the liquid growth medium, such that more of the growth medium is required. Less dense fiber materials have larger pore sizes, and the liquid level due to capillary action will be lower, such that a thinner fiber material is required. However, lower density thinner fiber material may be weaker and provide less protection due to movement of the substrate.

Preferably, the substrate has a thickness in the range of 0.6 to 4 cm, preferably 0.8 to 3.5 cm. The preferred thickness is especially suitable to be combined with the PET fiber material having a density of 14 to 19 kg/m³. Also, the substrate is thin enough such that in a reasonably sized container (e.g. having a height of 12 cm), the substrate takes up less than 30% of the height of the container in this example. The substrate thickness depends on the crop to be grown and the growth time thereof.

In an embodiment, the PET fiber material is a thermally bonded. In this way, no glue or the like is required and therefore no additional potential contaminants for food are introduced into the PET fiber material.

In an embodiment, the PET fiber material is nonwoven PET fiber material (nonwoven PET fabric). A nonwoven fabric is a fabric-like material made from fibres, which may be bonded together by chemical, mechanical, heat or solvent treatment. The thermally bonded nonwoven PET fiber material is preferred, as it has an increased strength. It is also a porous material having a suitable fluffiness, which is beneficial for allowing the growth medium to be transported through, and is suitable for allowing roots to grow through. In the textile manufacturing industry the term nonwoven is typically used to describe fabrics which are not woven or knitted.

According to a second aspect, there is provided a method of producing a substrate for use in a closed container for producing consumer-ready vegetables, mushrooms or herbs, the method comprising providing a polymer fiber based body having a porous structure, the polymer fiber based body comprising a sowing material receiving surface for receiving a sowing material of the vegetables, mushrooms or herbs, wherein the polymer fiber based comprises polyethylene terephthalate, PET, fiber material.

Preferably, the providing comprises sterilizing the polymer fiber based body.

In an embodiment, the sterilizing is performed by irradiating the polymer fiber based body with ionizing radiation. Alternatively, steam or any other suitable method of sterilizing may be used.

Preferably, the irradiating the polymer fiber based body with ionizing radiation comprises gamma ray irradiation from a cobalt 60 radioactive source, with an average dose in the range of 1-25 kGy. More preferred is an average dose in the range of 1-10 kGy. Beneficially, the PET fiber material requires an average dose of at most 10 kGy of radiation, which is the upper limit for food packaging as advised by the European Food Safety Authority.

It will be understood that any of the features and advantages of the method of the second aspect are applicable to any of the other aspects.

According to a third aspect, there is provided a substrate obtainable by the method of producing a substrate for use in a closed container for producing consumer-ready vegetables, mushrooms or herbs according to the second aspect.

According to a fourth aspect, there is provided a container for producing consumer-ready vegetables, mushrooms or herbs, comprising the substrate according to the first aspect; the sowing material of the vegetables, mushrooms or herbs provided on the sowing material receiving surface; growth medium in contact with a part of the substrate opposite the sowing material receiving surface; and a permeable membrane closing the container.

The permeable membrane preferably allows the exchange of growth-related substances such as oxygen and carbon dioxide, but blocks unwanted substances such as pathogens and contaminants. Examples of contaminants and pathogens are viruses, bacteria, fungi, protists or insects.

Preferably, the container and/or the permeable membrane are made of transparent plastic. In this way, the sowing material and plant or other material growing therefrom may suitably receive light such as visible light. The transparent plastic is preferably made of PET.

It will be understood that any of the containers according to the fourth aspect, comprising any one of the substrates and methods according to the first, second and third aspects is especially beneficial for producing consumer-ready vegetables, mushrooms or herbs, in view of the advantages of the substrate as outlined above.

According to a further aspect, there is provided a method for producing consumer-ready vegetables, mushrooms or herbs, comprising: placing sowing material of the vegetables, mushrooms or herbs on the sowing material receiving surface of the substrate according to any one of the previous aspects; providing growth medium into a container, such as one according to the fourth aspect; placing the substrate into the container, wherein the substrate and growth medium are in contact; and closing the container with a permeable membrane.

By virtue of the substrate, e.g. since it is sterile and suitable for use in the closed container, the consumer-ready vegetables, mushrooms or herbs are produced with a low loss rate.

The method preferably comprises sterilizing the substrate before the step of placing seeds on the substrate.

In an embodiment, the step of placing comprises providing a biocompatible adhesive layer on the substrate, are at least partially fixing the plurality of seeds to the surface of the substrate by the biocompatible adhesive.

The method preferably comprises allowing the vegetables, mushrooms or herbs to grow in the closed container under suitable growing conditions until maturity; and transferring the container to a retail outlet.

In another aspect, there is provided a kit comprising: a container, for instance any one container according to the fourth aspect; any one of the substrates according to any of the above aspects; sowing material of vegetables, mushrooms or herbs; and a permeable membrane for closing the container.

According to yet another aspect, there is provided the use of any one of the substrates according to any one of the previous aspects in a method of producing consumer-ready vegetables, mushrooms or herbs in a closed container.

The accompanying drawings are used to illustrate presently preferred non-limiting exemplary embodiments of devices of the present disclosure. The above and other advantages of the features and objects of the disclosure will become more apparent and the disclosure will be better understood from the following detailed description when read in conjunction with the accompanying drawings, in which:

FIG. 1 is a perspective view of a container comprising a substrate according to an embodiment of the present disclosure;

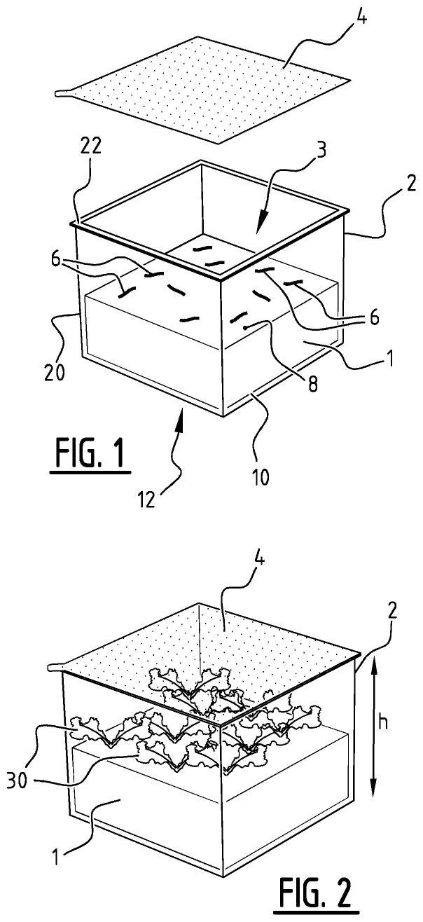

FIG. 2 is a perspective view of the container comprising a substrate according to FIG. 1, closed with a membrane and with a matured leafy vegetable;

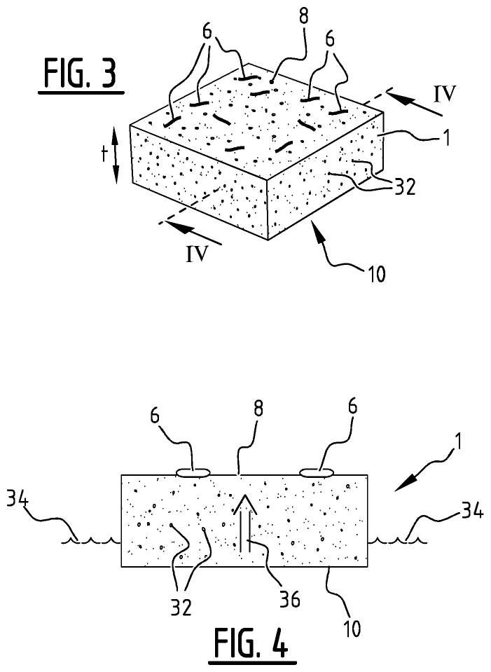

FIG. 3 is a perspective view of the substrate with sowing material or seeds according to an embodiment of the present disclosure; and

FIG. 4 is a cross section of the substrate of FIG. 3 as indicated therein. Container 2 comprises the substrate 1. The substrate 1 comprises a polymer fiber based body having a porous structure 32, as graphically depicted in FIG. 3. The polymer fiber based body comprises a sowing material receiving surface 8 for receiving sowing material 6 (e.g. seeds) of the vegetables, mushrooms or herbs. The polymer fiber based body of substrate 1 further comprises a growth medium uptake side 10 opposite the sowing material receiving surface 8. The growth medium uptake side 10, when the substrate is placed in the container, is in contact with an inner side of base 12 of the container 2.

Permeable membrane 4, also referred to as a semi-permeable membrane, is permeable to oxygen and carbon dioxide, but blocks pathogens and/or contaminants. In the arrangement of FIG. 1, the membrane 4 is not yet placed on the container 2. The membrane 4 may be placed on container 2, in particular on the flat rims 22 thereof, and heat bonded to the container to close the container. The closed container 2 is shown in FIG. 2.

Suitable growth medium is added to container 2 before closing the container 2. The growth medium can be added either before (preferred) or after the substrate is placed in the container. Before is preferred as the growth medium does not come into contact with the sowing material receiving surface 8, which is at the top side when in use in a standing container. The growth medium comprises water and may further comprise at least one of the ingredients from the group consisting of minerals (major salts as well as minor salts), sugars, trace elements, vitamins and amino acids.

In the closed container 2 of FIG. 2, the seeds have sprouted and grown into leafy vegetables 30, being at least partially matured. The container may be opened, the vegetables taken out, and consumed.

FIG. 3 shows a substrate 1 according to an embodiment. The substrate comprises sowing material 6 (e.g. seeds) deposited on the sowing material receiving surface 8 of the substrate 1. The substrate has a thickness t, which may be in the range of 0.6 to 4 cm. In this example, the thickness is 12 mm and the PET fiber material has a density of about 17 kg/m³. Although the size of the substrate is exaggerated in the figures, the combination of the thickness and densities, the substrate 1 has a thickness t that is less than 30% of the height h of the container 2, such that there is room for the growing plants 30. In this example h is 12 cm. The growing plants 30 in this example are frilled lettuce. The height h depends on which plants 30 or other crop are grown in the container 2.

The PET fiber material is, in an embodiment, a nonwoven PET material that is thermally bonded. Suitably, the sowing material receiving surface 8 of the substrate 1 has a surface evenness suitable for sprouting of seeds. The average pore size on the surface 8 is about 1 mm.

When growth medium is added to the container, the substrate 1 is partially submerged, with a fluid level 34 reaching a certain height of the substrate 1, as shown in FIG. 4. The growth medium is absorbed by the PET substrate 1 on the growth medium uptake side 10, and diffuses (e.g. via capillary action) upward towards the sowing material receiving surface 8 and the sowing material 6, as indicated by arrow 36, through the porous structure 36. The growth medium then reaches the seeds or other living material (e.g. roots) requiring water and optionally nutrients. The growth medium is gradually used up by the growing material, and the fluid level 34 drops. The fluid level 34 should not be too high to avoid submerging of the sowing material and/or growing crop. The amount of fluid required depends on the type of crop growing. The relative fluid level compared to the substrate can then be changed by changing the thickness t of the substrate.

The present invention is not limited to the present embodiments. The scope of protection is established by the content of the following claims within the scope of which many variations are feasible.

The disclosure further comprises the following clauses:

1. Substrate for producing consumer-ready vegetables, mushrooms or herbs in a closed container, the substrate comprising:

a polymer fiber based body having a porous structure, wherein the polymer fiber based body comprises a sowing material receiving surface for receiving sowing material of the vegetables, mushrooms or herbs,

wherein the polymer fiber based body comprises polyethylene terephthalate, PET, fiber material.

2. Substrate according to clause 1, further comprising the sowing material of the vegetables, mushrooms or herbs; and/or

wherein the polymer fiber based body consists of PET fiber material.

3. Substrate according to clause 2, further comprising a biocompatible adhesive provided on at least a part of a surface of the substrate, wherein at least a part of the sowing material is at least partially fixed to the sowing material receiving surface of the substrate using the biocompatible adhesive.

4. Substrate according to clause 3, further comprising a seed mat, wherein the sowing material is enclosed by, or at least partially fixed to, the seed mat.

5. Substrate according to clause 4, wherein the seed mat is fixed to the sowing material receiving surface using the biocompatible adhesive.

6. Substrate according to any one of clauses 1-5, wherein the polymer fiber based body is substantially sterile.

7. Substrate according to any one of clauses 1-6, wherein the PET fiber material has a density in the range of 5 to 40 kg/m³, preferably 10 to 20 kg/m³, more preferably 14 to 19 kg/m³.

8. Substrate according to any one of clauses 1-7, wherein the PET fiber material is a thermally bonded nonwoven PET fiber material.

9. Substrate according to any one of clauses 1-8, wherein the polymer fiber based has a thickness in the range of 0.6 to 4 cm, preferably 0.8 to 3.5 cm.

10. Container for producing consumer-ready vegetables, mushrooms or herbs, comprising the substrate according to any one of clauses 1-9;

the sowing material of the vegetables, mushrooms or herbs provided on the sowing material receiving surface;

growth medium in contact with a part of the substrate opposite the sowing material receiving surface; and

a permeable membrane closing the container.

11. Container according to clause 10, wherein the permeable membrane is configured to be permeable to oxygen and carbon dioxide, and to block pathogens.

12. Method of producing a substrate for use in a closed container for producing consumer-ready vegetables, mushrooms or herbs, the method comprising:

providing a polymer fiber based body having a porous structure, the polymer fiber based body comprising a sowing material receiving surface for receiving a sowing material of the vegetables, mushrooms or herbs,

wherein the polymer fiber based body comprises polyethylene terephthalate, PET, fiber material,

wherein the providing comprises sterilizing the polymer fiber based body.

13. Method according to clause 12, wherein the sterilizing is performed by irradiating the polymer fiber based body with ionizing radiation.

14. Method according to clause 13, wherein the irradiating the polymer fiber based body with ionizing radiation comprises gamma ray irradiation from a cobalt 60 radioactive source, with a dose in the range of 1-25 kGy, preferably 1-10 kGy.

15. Substrate obtainable by the method according to clause 12, 13 or 14.

16. Method for producing consumer-ready vegetables, mushrooms or herbs, comprising:

placing sowing material of the vegetables, mushrooms or herbs on the sowing material receiving surface of the substrate according to any one of clauses 1-9 and 15;

providing growth medium into a container;

placing the substrate into the container, wherein the substrate and growth medium are in contact; and

closing the container with a permeable membrane.

17. Method according to clause 16, further comprising: sterilizing the substrate before the step of placing sowing material on the substrate.

18. Method according to clause 16 or 17, wherein the step of placing comprises providing a biocompatible adhesive layer on the substrate, and at least partially fixing the sowing material to the surface of the substrate by the biocompatible adhesive.

19. Method according to clause 16, 17, or 18, further comprising:

allowing the vegetables, mushrooms or herbs to grow in the closed container under suitable growing conditions until maturity; and

transferring the container to a retail outlet.

20. Kit comprising:

a container;

the substrate according to any one of clauses 1 to 9 and 15; and

a permeable membrane for closing the container.

21. Kit according to clause 20, comprising the sowing material of vegetables, mushrooms or herbs.

22. Use of a substrate according to any one of clauses 1-9 and 15 for producing consumer-ready vegetables, mushrooms or herbs in a closed container.

1. Substrate for producing consumer-ready vegetables, mushrooms or herbs in a closed container, the substrate comprising:
a polymer fiber based body having a porous structure, wherein the polymer fiber based body comprises a sowing material receiving surface for receiving sowing material of the vegetables, mushrooms or herbs,
wherein the polymer fiber based body is made of only polyethylene terephthalate, PET, fiber material.

2. Substrate according to claim 1, further comprising the sowing material of the vegetables, mushrooms or herbs.

3. Substrate according to claim 2, further comprising a biocompatible adhesive provided on at least a part of a surface of the substrate, wherein at least a part of the sowing material is at least partially fixed to the sowing material receiving surface of the substrate using the biocompatible adhesive.

4. Substrate according to claim 3, further comprising a seed mat, wherein the sowing material is enclosed by, or at least partially fixed to, the seed mat.

5. Substrate according to claim 4, wherein the seed mat is fixed to the sowing material receiving surface using the biocompatible adhesive.

6. Substrate according to claim 1, wherein the polymer fiber based body is substantially sterile.

7. Substrate according to claim 1, wherein the PET fiber material has a density in the range of 5 to 40 kg/m³, preferably 10 to 20 kg/m³, more preferably 14 to 19 kg/m³.

8. Substrate according to claim 1, wherein the PET fiber material is a thermally bonded nonwoven PET fiber material.

9. Substrate according to claim 1, wherein the polymer fiber based has a thickness in the range of 0.6 to 4 cm, preferably 0.8 to 3.5 cm.

10. Container for producing consumer-ready vegetables, mushrooms or herbs, comprising
the substrate according to claim 1;
the sowing material of the vegetables, mushrooms or herbs provided on the sowing material receiving surface;
growth medium in contact with a part of the substrate opposite the sowing material receiving surface; and
a permeable membrane closing the container.

11. Container according to claim 10, wherein the permeable membrane is configured to be permeable to oxygen and carbon dioxide, and to block pathogens.

12. Method of producing a substrate for use in a closed container for producing consumer-ready vegetables, mushrooms or herbs according to claim 1, the method comprising:
providing a polymer fiber based body having a porous structure, the polymer fiber based body comprising a sowing material receiving surface for receiving a sowing material of the vegetables, mushrooms or herbs,
wherein the polymer fiber based body consists of polyethylene terephthalate, PET, fiber material.

13. Method according to claim 12, wherein the providing comprises sterilizing the polymer fiber based body, wherein preferably the sterilizing is performed by irradiating the polymer fiber based body with ionizing radiation.

14. Method according to claim 13, wherein the irradiating the polymer fiber based body with ionizing radiation comprises gamma ray irradiation from a cobalt 60 radioactive source, with a dose in the range of 1-25 kGy, preferably 1-10 kGy.

15. Method for producing consumer-ready vegetables, mushrooms or herbs, comprising:
placing sowing material of the vegetables, mushrooms or herbs on the sowing material receiving surface of the substrate according to claim 1;
providing growth medium into a container;
placing the substrate into the container, wherein the substrate and growth medium are in contact; and
closing the container with a permeable membrane.

16. Method according to claim 15, further comprising: sterilizing the substrate before the step of placing sowing material on the substrate.

17. Method according to claim 15, wherein the step of placing comprises providing a biocompatible adhesive layer on the substrate, and at least partially fixing the sowing material to the surface of the substrate by the biocompatible adhesive.

18. Method according to claim 15, further comprising:
allowing the vegetables, mushrooms or herbs to grow in the closed container under suitable growing conditions until maturity; and
transferring the container to a retail outlet.

19. Kit comprising:
a container;
the substrate according to claim 1; and
a permeable membrane for closing the container.

20. Kit according to claim 19, comprising the sowing material of vegetables, mushrooms or herbs.

21. (canceled)
